(19) United States
(12) Patent Application Publication
(10) Pub. No.: US 2017/0111186 A1
(43) Pub. Date: Apr. 20, 2017

(54) TRANSMISSION APPARATUS AND TRANSMISSION SYSTEM

(71) Applicant: FUJITSU LIMITED, Kawasaki-shi (JP)

(72) Inventor: Yuji Tochio, Yokohama (JP)

(73) Assignee: FUJITSU LIMITED, Kawasaki-shi (JP)

(21) Appl. No.: 15/277,617

(22) Filed: Sep. 27, 2016

(30) Foreign Application Priority Data
Oct. 20, 2015 (JP) 2015-206448

(51) Int. Cl. H04L 12/46; H04L 12/741; H04L 12/931

(52) U.S. Cl. CPC H04L 12/465; H04L 49/354; H04L 45/74

(57) ABSTRACT

An APS signal applied with a first VLAN ID is transmitted to a first protection path that is shared by first and second working paths #1 and #2, and an APS signal applied with a second VLAN ID is transmitted to a second protection path that is a protection path candidate for the second working path #2.

### CROSS-REFERENCE TO RELATED APPLICATION

This application is based upon and claims the benefit of priority of the prior Japanese Patent Application No. 2015-206448, filed on Oct. 20, 2015, the entire contents of which are incorporated herein by reference.

### FIELD

The embodiment(s) discussed herein is related to a transmission apparatus and a transmission system.

### BACKGROUND

As an example of a redundancy technology of a communication network, there is a technology called a shared mesh protection (SMP) or a shared mesh restoration (SMR).

The SMP or SMR has attracted attention for an example of a technology that provides a redundancy of a communication path (may be referred to as “path”) while achieving a transmission band efficiency in a communication network.

For example, since the SMP is available to provide or set a pre-configured redundant path, the SMP has attracted much attention in terms of a network operation. The ITU-T also proceeds with creating a standard for the SMP next to a linear ring protection. For example, the ITU-T proceeds with creating a standard for the SMP in an OTN.

The “ITU-T” is an abbreviation of the “International Telecommunication Union Telecommunication Standardization Sector”. The “OTN” is an abbreviation of the “Optical Transport Network”.

### RELATED ART DOCUMENT LIST

Patent Document 1: WO 2014/017162 A
Patent Document 2: JP 2013-236131 A
Patent Document 3: JP 2015-023458 A
Non-Patent Document 1: ITU-T recommendation G.8032
Non-Patent Document 2: ITU-T recommendation Y.1731
Non-Patent Document 3: RFC4328
Non-Patent Document 4: RFC7139

In the SMP or the SMR, a single protection path shared by a plurality of working path is prepared instead of preparing a plurality of protection pats respective for a plurality of working paths in terms of a transmission band efficiency.

In a case where a failure occurs in any one of the working paths, the working path is switched to the shared protection path. Therefore, communications in the working path in which the failure occurs are relieved with the protection path.

However, when a failure occurs in a second working path in a state where the shared protection path has already been used to relieve a first working path, it is unavailable to relieve communications in the second working path with the shared protection path.

In other words, in the SMP or the SMR, a protection path for a second working path may be lost due to a failure in a first working path. It is not favorable situation that a time period in which the protection path is lost and not secured occurs in terms of a communication reliability.

### SUMMARY

As one of aspects, a transmission apparatus may include a receiver and a transmitter. The receiver may receive from a first protection path an automatic protection switching (APS) signal indicating that a first working path in which a failure occurs is to be switched to a first protection path shared by the first working path and a second working path. The transmitter may transmit an APS signal applied with a first virtual local area network identifier (VLAN ID) to the first protection path in response to reception of the APS signal. In addition, the transmitter may transmit an APS signal applied with a second VLAN ID to a second protection path that is a protection path candidate for the second working path.

Further, as one of aspects, a transmission system may include a first working path, a second working path, a first protection path that is shared by the first working path and the second working path, a first transmission apparatus through which the first protection path is routed, and a second transmission apparatus through which the second working path is routed. The first transmission apparatus may transmit to the first protection path an automatic protection switching (APS) signal indicating that the first working path in which a failure occurs is to be switched to the first protection path. The second transmission apparatus may transmit an APS signal applied with a first virtual local area network identifier (VLAN ID) to the first protection path in response to a reception of the APS signal through the first protection path. In addition, the second transmission apparatus may transmit an APS signal applied with a second VLAN ID to a second protection path that is a protection path candidate for the second working path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a configuration example of a communication network according to an embodiment;

FIG. 2 is a diagram schematically illustrating a configuration example of a control plane corresponding to the communication network illustrated in FIG. 1;

FIG. 3 is a diagram schematically illustrating a control message that flows through the control plane illustrated in FIG. 2;

FIG. 4 is a diagram schematically illustrating an operation example to switch a working path in which a failure occurs in the communication network (in a data plane) illustrated in FIG. 1 to a protection path of a shared section by using the control plane;

FIG. 5 is a flowchart illustrating an operation example corresponding to the operation example illustrated in FIG. 4;

FIG. 6 is a diagram schematically illustrating that flag information indicative of a “valid” or an “invalid” is set to a control message according to the embodiment;

FIG. 7 is a diagram illustrating a format example of the control message according to the embodiment;

FIG. 8 is a diagram schematically illustrating an operation example of the communication network according to the embodiment;

FIG. 9 is a flowchart illustrating an operation example of a node according to the embodiment;

FIG. 10 is a flowchart illustrating the operation example of the node according to the embodiment;

FIGS. 11 and 12 are block diagrams illustrating a configuration example of the node according to the embodiment;

FIG. 13 is a diagram illustrating an example of a path state management table illustrated in FIGS. 11 and 12;

FIG. 14 is a diagram illustrating an example of a path switch management table illustrated in FIGS. 11 and 12;

FIGS. 15 to 17 are diagrams illustrating an example of the path state management table illustrated in FIGS. 11 and 12;

FIG. 18 is a diagram schematically illustrating an operation example of a communication network according to a first modification example of the embodiment;

FIGS. 19 and 20 are diagrams schematically illustrating a configuration example and an operation example of the communication network according to the first modification example;

FIG. 21 is a flowchart illustrating an operation example of a node according to the first modification example;

FIG. 22 is a block diagram illustrating a configuration example of the node according to the first modification example;

FIG. 23 is a diagram schematically illustrating a configuration example and an operation example of a communication network according to a second modification example of the embodiment;

FIG. 24 is a flowchart illustrating an operation example of a node according to the second modification example;

FIG. 25 is a block diagram illustrating a configuration example of the node according to the second modification example; and

FIG. 26 is a block diagram illustrating an example of a hardware configuration of the node according to the embodiment including the first and second modification examples.

### DESCRIPTION OF EMBODIMENTS

Hereinafter, an embodiment will be described with reference to the drawings. However, the embodiment described below is only illustrative and does not intend to exclude application of various modifications and technologies that are not explicitly described below. Further, various exemplary aspects described below may be optionally combined and carried out. In addition, components assigned the same reference numeral in the drawings used for the following embodiment will represent identical or same components unless otherwise specified.

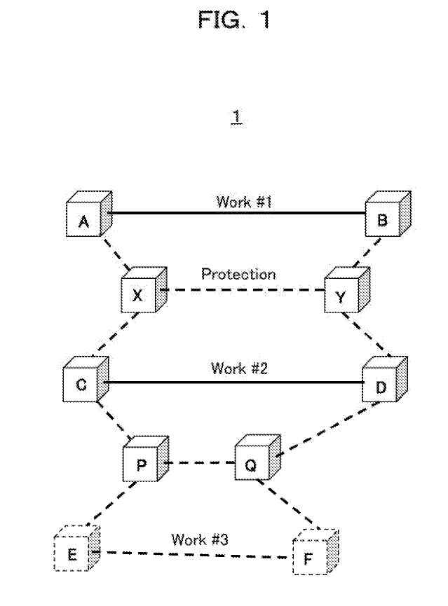

FIG. 1 is a block diagram illustrating a configuration example of a communication network according to an embodiment. The communication network 1 illustrated in FIG. 1 may be referred to as a “transmission system 1”. The transmission system 1 may be provided with a plurality of communication nodes A to F, X, Y, P, and Q, each of which is an example of a transmission apparatus.

The “communication network” and the “communication node” may be abbreviated as the “network” and the “node”, respectively. Each of the nodes A to F, X, Y, P, and Q is an example of an element (NE) of the network 1 and may be communicably connected with each other in a mesh to form a mesh network. FIG. 1 illustrates a case where the number of NEs is 10, but the number of NEs is not limited to “10”.

As illustrated in FIG. 1, a first working path #1 may be set between the nodes A and B, and a second working path #2 may be set between the nodes C and D. One or more of nodes may be provided between the nodes A and B. Similarly, one or more of nodes may be provided between the nodes C and D.

A protection path routed through nodes A, X, Y, and B may be set for the first working path #1. Further, a protection path routed through the nodes C, X, Y, and D may be set for the second working path #2.

The protection path between the nodes X and Y may be shared by the working paths #1 and #2. Therefore, a section between the nodes X and Y set with the shared protection path may be referred to as a “shared section” for descriptive purposes.

In a case where a failure occurs in any one of the working paths #1 and #2, communications in the failure-occurred working path can be relieved with the protection path that is routed through the shared section. One or more of nodes may be provided between the nodes X and Y.

Further, another protection path may also be set between the nodes P and Q. The protection path between the nodes P and Q may be shared by a third working path #3 that is another working path different from the first and second working paths #1 and #2. For example, the third working path #3 may be set between the nodes E and F. One or more of nodes may be provided between the nodes P and Q.

The protection path routed through the nodes X and Y is an example of a first protection path, and the protection path routed through the nodes P and Q is an example of a second protection path.

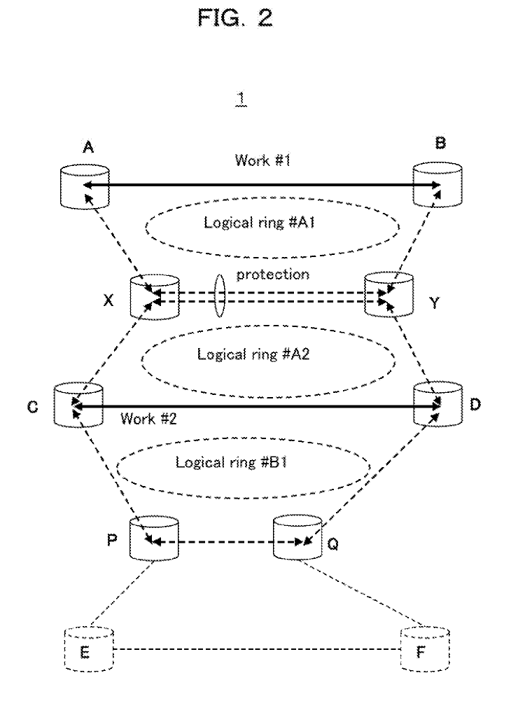

FIG. 2 illustrates a configuration example of a control plane corresponding to the network 1 illustrated in FIG. 1. A control signal is transmitted in the control plane. The control signal may include a control message that controls a path setting and/or a path switch. The control message is an example of a control signal.

For example, the control of the path setting and/or the path switch may be achieved by an operation based on an automatic protection switching operation of an Ethernet (registered trademark) ring protection (ERP). The ERP is described in the ITU-T recommendation G.8032. Hereinafter, the APS of the ERP may be referred to as a “ring APS” or an “R-APS” for descriptive purposes.

As illustrated in FIG. 2, a logical ring may be set for each path in the control plane in order to achieve the SMP or the SMR in the network 1. As mentioned above, the SMP is an abbreviation of a “shared mesh protection” and the SMR is an abbreviation of a “shared mesh restoration”.

For example, a logical ring #A1 may be set to a ring route formed by the nodes A, X, Y, and B. Further, a logical ring #A2 may be set to a ring route formed by the nodes X, C, D, and Y. Furthermore, a logical ring #B1 may be set to a ring route formed by the nodes C, P, Q, and D.

A control message of the R-APS may be transmitted in each of the logical rings #A1, #A2, and #B1. The control message may be referred to as an “R-APS message” for descriptive purposes. The R-APS message is an example of an APS signal.

The R-APS messages transmitted through the logical rings #A1, #A2, and #B1 may be referred to as an “R-APS #A1”, an “R-APS #A2”, and an “R-APS #B1”, respectively, for descriptive purpose.

For example, each of the R-APS messages may be periodically transmitted from each node. For example, in a case where a failure does not occur in the network 1, all of the nodes in the network 1 may transmit the R-APS message indicative of no request (NR) for a path setting and/or a path switch.

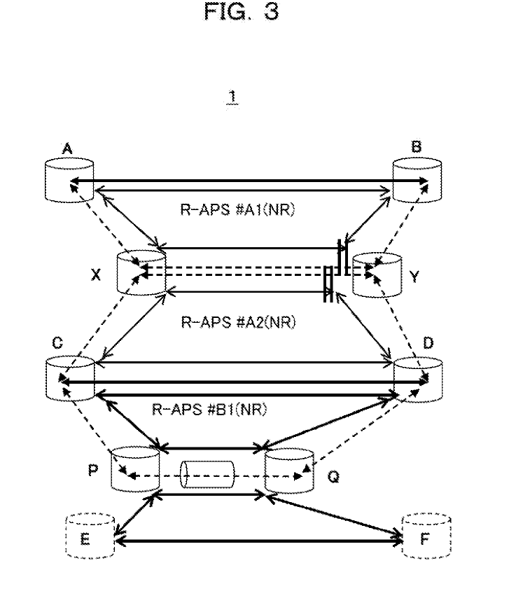

For example, as illustrated in FIG. 3, in a case where a failure does not occur in any of the working paths #1 and #2, the R-APS message indicative of the “NR” may be transmitted in each of the logical rings #A1, #A2, and #B1. The R-APS message indicative of the “NR” may be referred to as an “NR message” for descriptive purposes.

In FIG. 3, the NR messages transmitted in the logical rings #A1, #A2, and #B1 are denoted by “R-APS #A1(NR)”, “R-APS #A2(NR)”, and “R-APS #B1(NR)”, respectively. The same notation rule may also be applied to the descriptions for an SF message and an FS message.

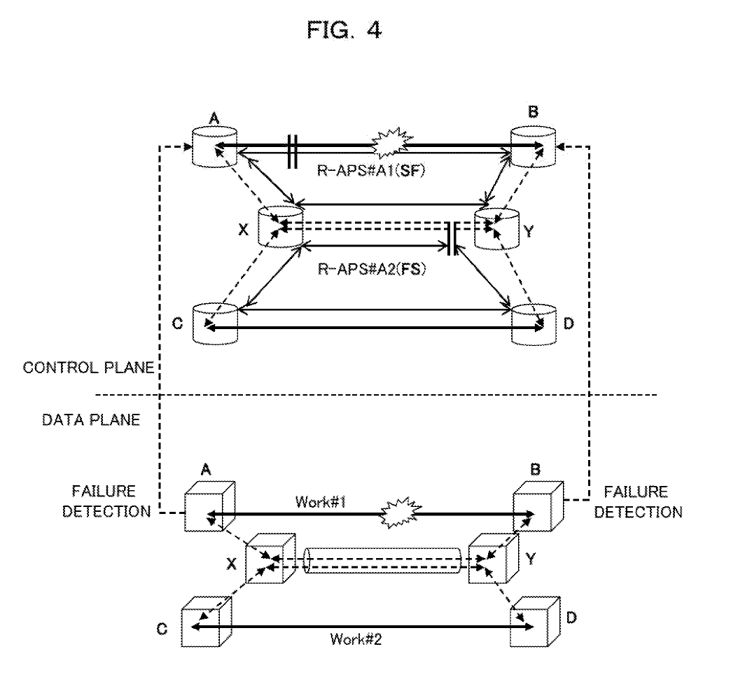

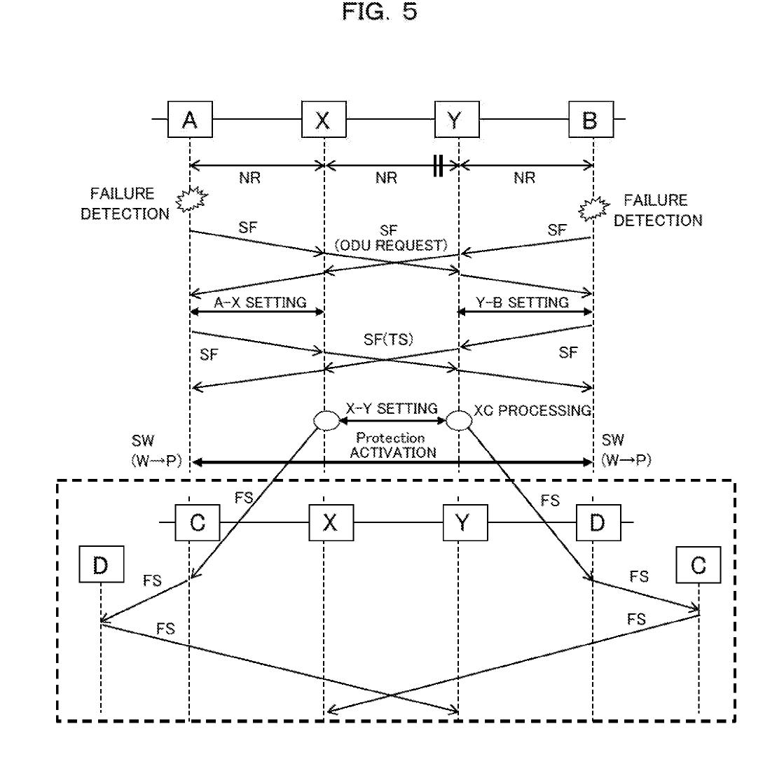

Hereinafter, descriptions will be made for an operation example to switch the working path #1 to the protection path that is routed through the shared section (between the nodes X and Y) by using the control plane when a failure occurs in a data plane of the working path #1 with reference to FIGS. 4 and 5. The “data plane” is used for transferring of data between nodes. The data transmitted in the data plane may be client data.

When a failure occurs between the nodes A and B in the data plane, the failure is detected by both of the nodes A and B. The nodes A and B transmit an R-APS message indicative of a signal fail (SF) to the logical ring #A1 in the control plane in response to a detection of the failure. The R-APS message indicative of the “SF” may be referred to as an “SF message” for descriptive purposes.

For example, the node A may transmit an SF message to the node X in response to a detection of the failure in the working path #1, and the node X may transmit an SF message to the node Y in response to a reception of the SF message from the node A.

The SF message may be set with information which requests for a path setting between the nodes Y and B. The information which requests for the path setting may include a path identifier of the working path #1 for which the failure is detected and/or information on transmission capacity (may be referred to as “transmission speed” or “transmission band”) information, for example.

The node Y may transmit an SF message to the node B in response to a reception of the SF message from the node X. The node B may set a path between the nodes B and Y in response to a reception of the SF message from the node Y. In a case where the information on the transmission capacity is included in the SF message, the node B is available to set a path which supports the transmission capacity between the nodes B and Y.

Meanwhile, the node B may transmit an SF message to the node Y in response to a detection of the failure in the working path #1, and the node Y may transmit an SF message to the node X in response to a reception of the SF message from the node B.

The SF message may be set with information which requests for a path setting between the nodes X and A. The information which requests for the path setting may include a path identifier and/or information on transmission capacity of the working path #1 for which a failure is detected, for example.

The node X may transmit an SF message to the node A in response to a reception of the SF message from the node Y. The node A may set a path between the nodes A and X in response to a reception of the SF message from the node X. In a case where the information on the transmission capacity is included in the SF message, the node A is available to set a path which supports the transmission speed between the nodes A and X.

When the path between the nodes A and X and the path between the nodes B and Y are successfully set, the nodes A and B may transmit SF messages again to the nodes X and Y, respectively. Each of the SF messages may be set with information that designates a tributary slot (TS) (may be abbreviated as “TS information”).

The TS is an example of a time-division slot, and client data is transmitted by being mapped to the TS. The nodes X and Y may set a switch thereof so that data is transmitted by the TS designated by the TS information in the protection path between the nodes X and Y, in response to a reception of the SF message set with the TS information from the nodes A and B, respectively.

Thereby, in the nodes X and Y, a setting of cross connect (XC) processing according to the switch setting is performed, and thus, the protection path between the nodes X and Y is activated, and switching from the working path #1 to the protection path is completed.

In response to the switching from the working path #1 to the protection path, the nodes X and Y may transmit an R-APS message indicating that the protection path is not available to relieve the working path #2 to the logical ring #A2 of the control plane.

For example, an R-APS message indicative of a forced switching (FS) may be applicable to the R-APS message. The R-APS message indicative of the FS may be referred to as an “FS message” for descriptive purposes.

For example, the nodes X and Y may transmit the FS message indicative of the forced switching to the working path #2 to the nodes C and D, respectively.

The nodes C and D respectively recognize that the protection path is not available in response to a reception of the FS message from the nodes X and Y and maintain a selection of the working path #2.

In a case where a failure occurs in the working path #2 among the working paths #1 and #2, an SF message is transmitted in the logical ring #A2, and an FS message is transmitted in the logical ring #A1.

Accordingly, the working path #2 between the nodes C and D is switched to a path that is routed through the protection path between the nodes X and Y, and the nodes A and B which do not detect a failure maintain a selection of the working path #1.

As described above, when the protection path in the shared section is actually used to relieve a failure in any of the working paths, a state in which a protection path is not prepared or secured for another working path that shares the protection path is occurred.

Therefore, when multiple failures occurs in two or more working paths that share the protection path, a relief of communications fails. The SMP or the SMR is a technology which originally allows such risk.

However, it is not a favorable situation in which a protection path for a working path is lost in response to an occurrence of a failure in another working path.

Therefore, in the embodiment, a second protection path different from a first protection path may be set in the control plane for at least one of first and second working paths that share the first protection path. For example, the second protection path may be shared by a third working path different from the first and second working paths.

For example, in FIG. 2, the working path #1 between the nodes A and B may correspond to the “first working path”, and the working path #2 between the nodes C and D may correspond to the “second working path”. Further, the protection path routed through the nodes X and Y may correspond to the “first protection path”, and the protection path routed through the nodes P and Q may correspond to the “second protection path”.

As mentioned above, the second protection path routed through the nodes P and Q may be shared by the working path #2 between the nodes C and D and the third working path #3 different from the working paths #1 and #2.

The node X or Y is an example of a first node through which the first protection path is routed, and the node C or D is an example of a second node through which the second working path #2 is routed.

In order to set the second protection path for the working path #2 between the nodes C and D in a route routed through the nodes C, P, Q, and D in addition to the first protection path between the nodes X and Y, an R-APS message may be transmitted in the logical ring #B1, for example.

As mentioned above, since the logical ring #B1 is a ring route formed by the nodes C, P, Q, and D in the control plane, it is possible to set and control an APS operation of the nodes C, P, Q, and D by transmitting the R-APS message to the logical ring #B1.

The logical ring #B1 may be pre-configured, or may be set depending on a usage state of the first protection path routed through the nodes X and Y. Hereinafter, descriptions will be made under an assumption in which the logical ring #B1 is pre-configured for descriptive purposes.

With focusing on the nodes C and D, the R-APS message (R-APS #A2) transmitted in the logical ring #A2 and the R-APS message (R-APS #B1) transmitted in the logical ring #B1 flow in the control plane between the nodes C and D.

The R-APS #A2 is an example of a control message available to set and control an APS operation for the first protection path routed through the nodes X and Y. The R-APS #B1 is an example of a control message available to set and control an APS operation for the second protection path routed through the nodes C and D.

Accordingly, two R-APS messages flow between the nodes C and D. Priority may be set to the two R-APS messages. For example, the R-APS #A2 may be set as a primary and the R-APS #B1 may be set as a secondary.

Further, since the two R-APS messages that flow between the nodes C and D include the same path ID (for example, an ID of the working path #2), information available to identify the two R-APS messages at the nodes C and D may be applied to the R-APS messages.

The information available to identify the two R-APS messages may also be referred to as an “R-APS identifier” for descriptive purposes. As a non-limiting example, a virtual local area network identifier (VLAN ID) may be applicable to the R-APS identifier.

For example, in the nodes C and D, the two R-APS messages may be input and output through different ports which correspond to the logical rings #A2 and #B1. In this case, by applying a VLAN ID for each port to the R-APS message, it is possible to identify the two R-APS messages.

For example, the node C or D may transmit an R-APS message applied with a first VLAN ID to the logical ring #A2 corresponding to the first protection path. The node C or D may transmit an R-APS message applied with a second VLAN ID different from the first VLAN ID to the logical ring #B1 corresponding to the second protection path that is a protection path candidate for the second working path #2.

The R-APS message is set with flag information indicating whether the R-APS message is a “valid” or an “invalid”. With the flag information, it is possible to control a logical ring to be activated or deactivated for an APS operation based on the R-APS message among the logical rings #A1, #A2, and #B1.

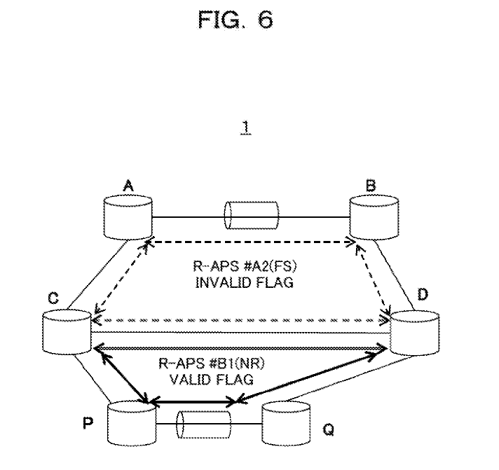

For example, as illustrated in FIG. 6, the R-APS #A2(FS) may be set with flag information indicative of an “invalid” (may be referred to as an “invalid flag”), and the R-APS #B1(NR) may be set with flag information indicative of a “valid” (may be referred to as a “valid flag”).

In this case, an APS operation based on the R-APS #A2(FS) being set with the invalid flag in the logical ring #A2 is deactivated, and an APS operation based on the R-APS #B1(NR) being set with the valid flag in the logical ring #B1 is activated.

The “invalid” may be indicated by flag information of “1” (yes), and the “valid” may be indicated by flag information of “0” (no). A change of the flag information from “1” to “0” may be referred to as a “flag off”. Therefore, it can be considered that the APS operation is activated by the “flag off”.

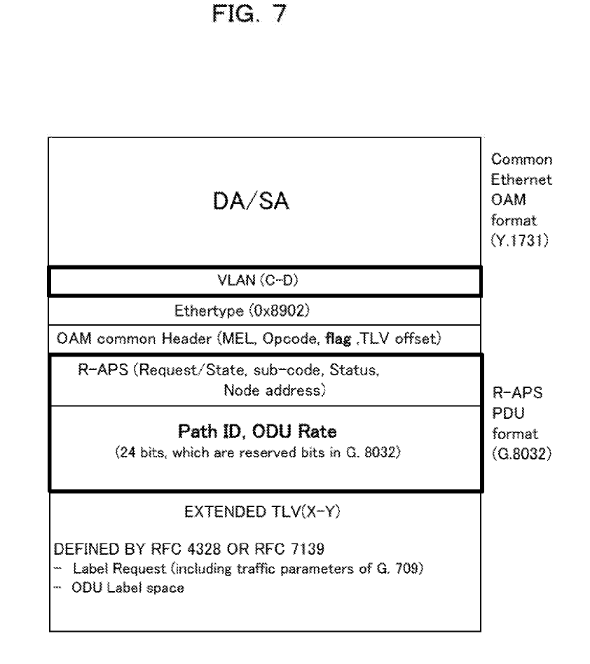

Next, FIG. 7 illustrates a format example of the R-APS message according to the embodiment. As illustrated in FIG. 7, the R-ARS message may include a DA/SA field, a VLAN field, an Ethernet type field, an OAM common header field, and an R-APS protocol data unit (PDU). Optionally, the R-APS message may be provided with an extended TLV (type-length-value) field.

For example, the aforementioned VLAN ID may be set to the VLAN field, and the aforementioned flag information may be set to the OAM common header field. The “OAM” is an abbreviation of an “operations, administration, and maintenance”.

The DA/SA field may be set with a destination address and a source address of the R-APS message. The Ethernet type field may be set with information indicative of an Ethernet type (for example, 0x8902).

The R-APS PDU may be set with a content of the R-APS message (for example, NR, SF, or FS), the path ID, and the transmission capacity information, for example. The path ID and the information indicative of the transmission capacity may be set to a reserve field of 24 bits, which is prepared in the R-APS PDU.

The extended TLV field may be applied (or attached) to the R-APS message transmitted through the shared section. The extended TLV field may be set with the aforementioned transmission capacity and/or information of the TS(s).

For example, the extended TLV field may comply with a “Label Request (including traffic parameters in the G.709)” and a “Label Space” which are described in the “RFC4328” or the “RFC7139”. The “transmission capacity” may be notified between nodes by using the “Label Request”. The TS information may be notified between nodes by using the “Label Space”.

### Operation Example

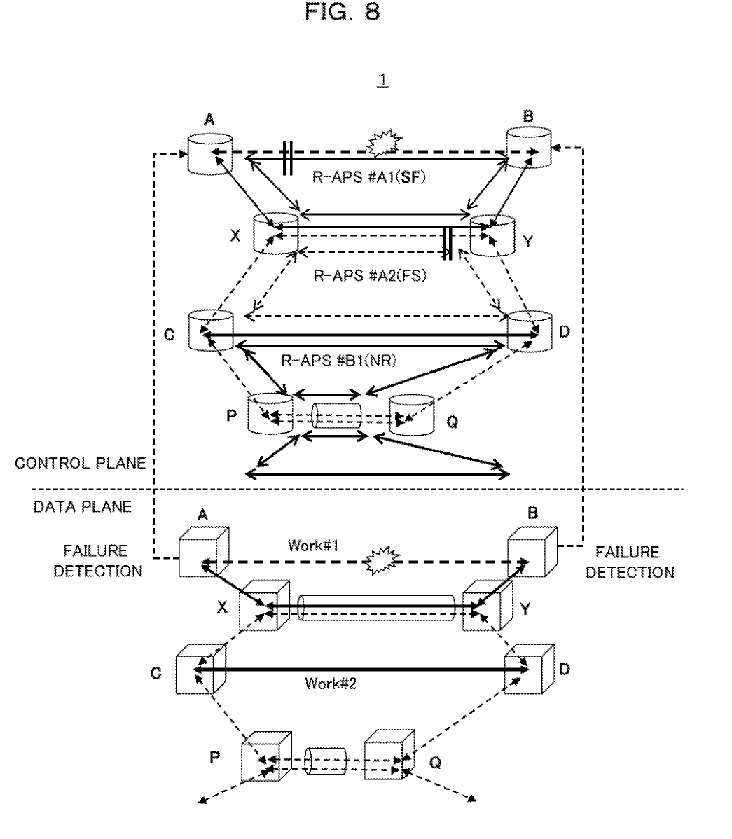

Hereinafter, descriptions for an operation example of the embodiment will be made with reference to FIGS. 8 to 10.

As illustrated in FIG. 8, when a failure occurs in the working path #1 between the nodes A and B, the SF message is transmitted to the logical ring #A1 from the respective nodes A and B.

Upon receiving the SF message through the logical ring #A1, each of the nodes X and Y, which forms the logical ring #A1 in combination with the nodes A and B, transmits the FS message to the logical ring #A2.

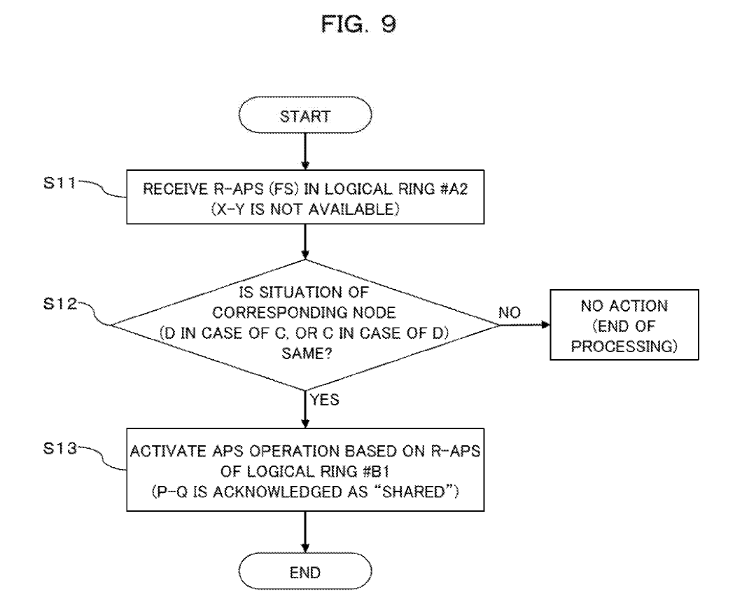

Each of the nodes C and D, which forms the logical ring #A2 in combination with the nodes X and Y, receives the FS message transmitted to the logical ring #A2 from each of the nodes X and Y (processing S11 in FIG. 9). In response to a reception of the FS message, each of the nodes C and D recognizes that a protection path routed through the nodes X and Y is already used to relieve the failure in the working path #1 between the nodes A and B and that a switching to the protection path routed through the nodes X and Y is unavailable.

The node C that receives the FS message may confirm that the node D corresponding to a counterpart of the node C in the working path #2 also receives the FS message as in the node C (processing S12 in FIG. 9).

For example, when the node C receives the FS message from the node D through the logical ring #A2, the node C may determine that the node D also receives the FS message as in the node C.

Similarly, the node D may also confirm that the node C corresponding to a counterpart of the node C in the working path #2 receives the FS message as in the node D (processing S12 in FIG. 9).

When the nodes C and D confirm that the counterpart nodes D and C do not receive the FS message, or when the nodes C and D are not able to confirm a state of the counterpart nodes D and C (NO in processing S12), the nodes C and D may end the processing without taking any actions.

Meanwhile, when the nodes C and D confirm that the counterpart nodes D and C receives the FS message (YES in processing S12), the nodes C and D may set the valid flag to an R-APS message to be transmitted to the logical ring #B1. In addition, the nodes C and D may set the valid flag (i.e., flag-off) to an FS message to be transmitted to the logical ring #A2 (processing S13 in FIG. 9).

Thereby, the nodes C and D deactivate the APS operation based on the R-APS message in the logical ring #A2, and activate the APS operation based on the R-APS message in the logical ring #B1. Accordingly, the nodes C and D recognize that a protection path routed through the nodes P and Q is in a state available to be used for the working path #2.

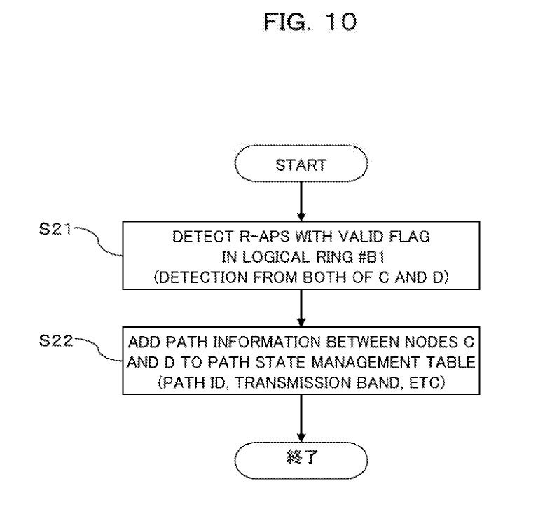

Meanwhile, when the nodes P and Q receives the R-APS message with the “flag-off” from both of the nodes C and D through the logical ring #B1 (processing S21 in FIG. 10), the nodes P and Q may store information relating to the working path #2 that is routed through the nodes C and D (processing S22 in FIG. 10).

As described in FIG. 7, the information relating to the working path #2 may include the path ID and/or the transmission capacity information of the working path #2. The information relating to the working path #2 may be stored and managed in a path state management table described later.

Thereby, the nodes P and Q are in a state available to use the protection path between the nodes P and Q for the working path #2 with the same transmission capacity as that of the working path #2. In other words, it is possible to set the protection path between the nodes P and Q as a new protection path for the working path #2 instead of the protection path in the shared section (between the nodes X and Y), which has already been used to relieve the failure-occurred working path #1.

When a failure occurs in the working path #2, the nodes C, D, P, and Q operate in accordance with the R-APS message transmitted through the logical ring #B1. Thus, the working path #2 can be switched to the protection path routed through the nodes P and Q.

### Configuration Example of Node

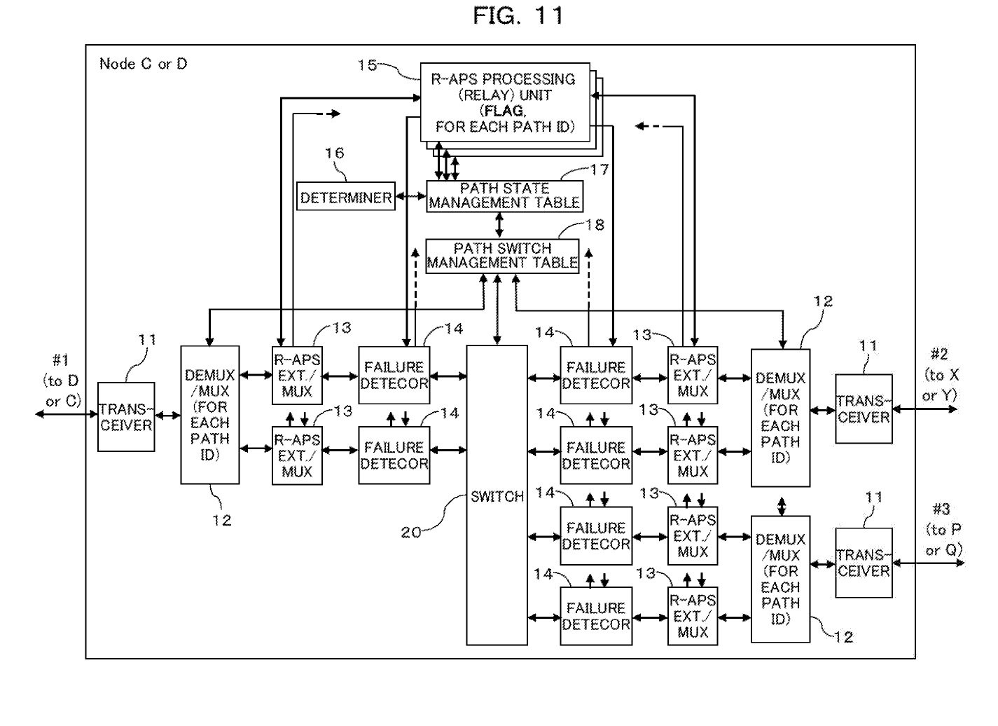

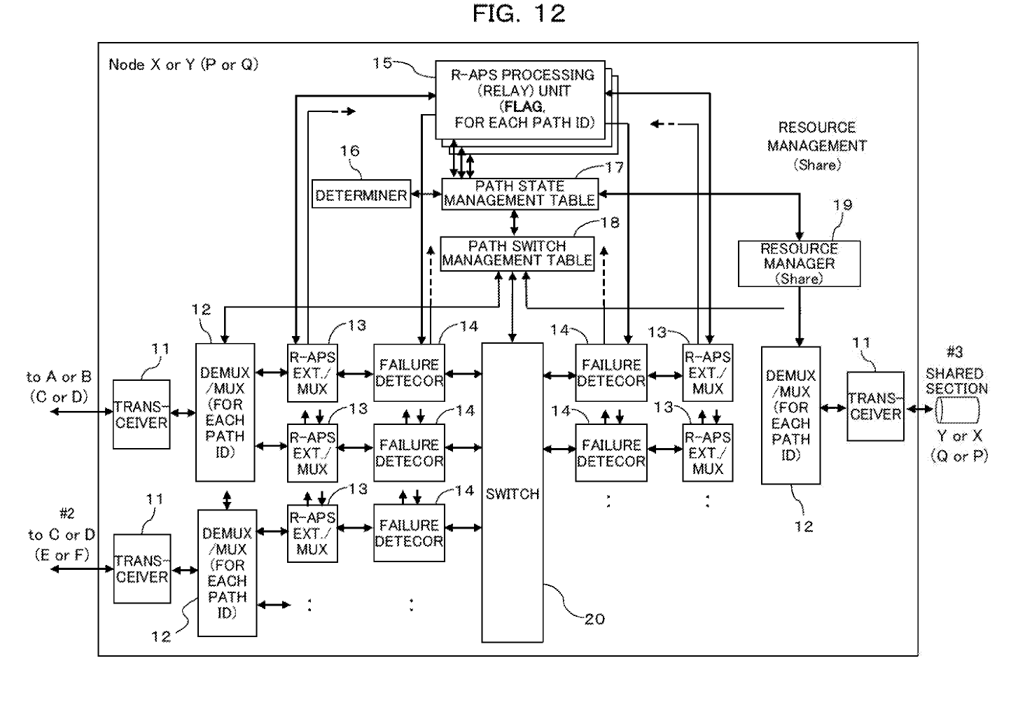

Next, descriptions will be made for a configuration example of the nodes C, D, X, Y, P, and Q, which are available to achieve the above-described operation example, with reference to FIGS. 11 and 12.

FIG. 11 is a block diagram illustrating a configuration example of the node C or D, and FIG. 12 is a block diagram illustrating a configuration example of the node X, Y, P, or Q. The configuration example illustrated in FIG. 11 may be common to the nodes C and D, and the configuration example illustrated in FIG. 12 may be common to the nodes X, Y, P, and Q. The configuration example illustrated in FIG. 11 may also be common to the nodes A and B.

As illustrated in FIG. 11, the nodes C and D may include a transceiver 11, a demultiplexer and multiplexer unit (DEMUX/MUX) 12, an R-APS extractor and multiplexer unit (R-APS EXT/MUX) 13, a failure detector 14, an R-APS processor 15, a determiner 16, a path state management table 17, a path switch management table 18, and a switch 20.

A set of the transceiver 11, the DEMUX/MUX 12, the R-APS EXT/MUX 13, and the failure detector 14 may be provided for each physical communication path connected to another node.

For example, with focusing on the node C, the node C may include three sets of the transceiver 11, the DEMUX/MUX 12, the R-APS EXT/MUX 13, and the failure detector 14 in correspondence with respective communication paths (#1 to #3) connected to the nodes D, X, and P.

Meanwhile, with focusing on the node D, the node D may include three sets of the transceiver 11, the DEMUX/MUX 12, the R-APS EXT/MUX 13, and the failure detector 14 in correspondence with respective communication paths (#1 to #3) connected to the node C, Y, and Q.

The transceiver 11 may terminate a signal received through a communication path connected to another node, and may transmit a signal to a communication path connected to another node.

The DEMUX/MUX 12 may demultiplexes received signals for each path ID based on the path switch management table 18, and may output the demultiplexed signal to the R-APS EXT/MUX 13 corresponding to the path ID. Further, the DEMUX/MUX 12 may multiplex signals for each path ID, which are to be transmitted to another node.

The R-APS EXT/MUX 13 may be provided for each path ID and may extract an R-APS message from a received signal with a corresponding path ID to output the extracted R-APS message to the R-APS processor 15. Further, the R-APS EXT/MUX 13 may multiplex R-APS messages generated in the R-APS processor 15 into a signal from the switch 20.

The failure detector 14 may be provided for each path ID, and detects a failure in a path. For example, when a frame synchronization of a received signal with a corresponding path ID is not able to be established, the failure detector 14 may determine that a failure occurs in a path of the corresponding path ID.

The R-APS processor 15 may process the R-APS message. The R-APS processor 15 may be provided for each path ID. The processing S11 to processing S13 illustrated in FIG. 9 may be performed by the R-APS processor 15.

The R-APS processor 15 may perform a reception processing, a relay processing, and a transmission processing of the R-APS message based on the path state management table 17. The R-APS processor 15 may update the path state management table 17 in accordance with results of each processing.

For example, an FS message indicating that the working path #1 between the nodes A and B is to be switched to the protection path routed through the nodes X and Y is received and extracted by the R-APS EXT/MUX 13 corresponding to any one of the communication paths #1 to #3. The extracted FS message is received and processed by the R-APS processor 15.

Therefore, the R-APS EXT/MUX 13 can be considered as corresponding to an example of a first receiver that receives an FS message indicating that the working path #1 is to be switched to a first protection path.

In response to the reception processing of the FS message, the R-APS processor 15 may generates an R-APS message applied with a first VLAN ID and an invalid flag, and an R-APS message applied with a second VLAN ID and a valid flag.

The R-APS message applied with the first VLAN ID is given to the R-APS EXT/MUX 13 corresponding to any one of the communication paths #1 to #3, and is transmitted to the first protection path routed through the nodes X and Y.

Meanwhile, the R-APS message applied with the second VLAN ID is given to the R-APS EXT/MUX 13 corresponding to any one of the communication path #1 to #3, and is transmitted to the second protection path routed through the nodes P and Q.

Therefore, the R-APS EXT/MUX 13 is also an example of a first transmitter that transmits the R-APS message applied with the first VLAN ID to the first protection path and transmits the R-APS message applied with the second VLAN ID to the second protection path.

The determiner 16 may determine a path state based on the received R-APS message and the path state management table 17, and may determine an R-APS message to be transmitted to another node.

The path state management table 17 and the path switch management table 18 may be common to the nodes X, Y, P, and Q illustrated in FIG. 12. Thus, an example of the tables 17 and 18 will be described together with descriptions of a configuration example of the nodes X, Y, P, and Q illustrated in FIG. 12.

The switch 20 may perform a setting of an internal signal route, in other words, a cross connect setting, based on the path switch management table 18.

Meanwhile, the nodes X, Y, P, and Q illustrated in FIG. 12 may include three sets of the transceiver 11, the DEMUX/MUX 12, the R-APS EXT/MUX 13, and the failure detector 14 in correspondence with the three communication paths #1 to #3.

For example, upon focusing on the node X, the node X may include three sets of the transceiver 11, the DEMUX/MUX 12, the R-APS EXT/MUX 13, and the failure detector 14 in correspondence with the communication paths #1 to #3 between the nodes X and A, between the nodes X and C, and between the nodes X and Y.

Upon focusing on the node Y, the node Y may include three sets of the transceiver 11, the DEMUX/MUX 12, the R-APS EXT/MUX 13, and the failure detector 14 in correspondence with the communication paths #1 to #3 between the nodes Y and B, between the nodes Y and D, and between the nodes Y and X.

Upon focusing on the node P, the node P may include three sets of the transceiver 11, the DEMUX/MUX 12, the R-APS EXT/MUX 13, and the failure detector 14 in correspondence with the communication paths #1 to #3 between the nodes P and C, between the nodes P and E, and between the nodes P and Q.

Upon focusing on the node Q, the node Q may include three sets of the transceiver 11, the DEMUX/MUX 12, the R-APS EXT/MUX 13, and the failure detector 14 in correspondence with the communication paths #1 to #3 between the nodes Q and D, between the nodes Q and F, and between the nodes Q and P.

Further, as illustrated in FIG. 12, the nodes X, Y, P, and Q may additionally include a resource manager 19 in comparison with the configuration example of the node C and D illustrated in FIG. 11. Furthermore, the R-APS processor 15 of the nodes X, Y, P, and Q may be different from that of the nodes C and D in that the former R-APS processor 15 performs the processing S21 and S22 illustrated in FIG. 10.

For example, upon receiving the R-APS message applied with the valid flag, the R-APS processor 15 of the node P or Q updates the path state management table 17 so that a protection path between the nodes P and Q is available to be used for a relief of the working path between the nodes C and D.

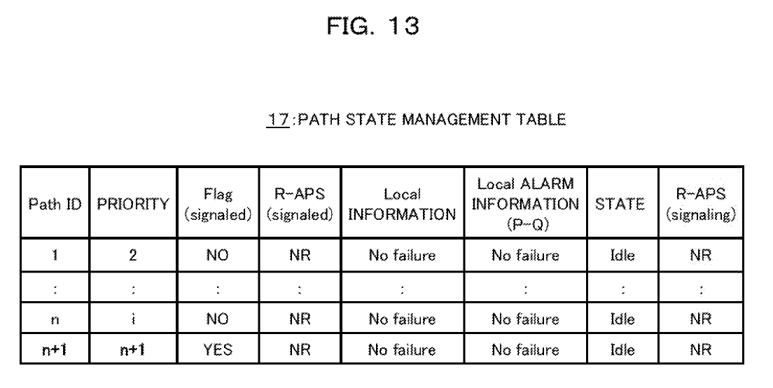

As illustrated in FIG. 13, information for a management of a path state may be registered in the path state management table 17 for each path ID. In FIG. 13, a “priority” indicates a priority of a path. For example, the priority of a path may be pre-set by a user or a network manager.

A “Flag (signaled)” indicates flag information of the received R-APS message. The “Priority” of a path may be controlled by the “flag”.

An “R-APS (signaled)” indicates a type of the received R-APS message. The “R-APS (signaling)” indicates a type of the R-APS message to be transmitted (or signaled). Examples of the type of the R-APS message may include the NR, the SF, and the FS described above.

“Local information” indicates a state whether or not a failure occurs between the node C or D and another node. “Local alarm information” indicates whether or not an alarm is detected between the node C or D and the node X or Y (or node P or Q) that constitutes the shared section.

A “State” represents a path state. The path state may take any one of possible states of “idle”, “protection”, and “fail”. For example, when a working path is switched to a protection path in response to a detection of a failure of a path in an “idle” state, the path state transitions from the “idle” state to a “protection” state.

When the protection path is switched back to the working path in response to a recovery of the failure of the path in the “protection” state, the path state transitions from the “protection” state to an “idle” state. When a working path is not available to be switched to a protection path in response to a detection of a failure in a path in the “idle” state, the path state transitions from the “idle” state to a “fail” state.

When the failure of the path in the “fail” state is recovered, the path state transitions from the “fail” state to an “idle” state. When a protection path corresponding to a path in the “protection” state becomes unavailable by performing a priority control between paths, the path state transitions from the protection” state to a “fail” state. When a protection path corresponding to a path in the “fail” state becomes available by performing the priority control between paths, the path state transitions from the “fail” state to the “protection” state.

In FIG. 13, a path ID=“n+1” indicates a protection path ID for the working path #2 between the nodes C and D.

FIG. 13 indicates a state where the path between the nodes P and Q is not provided as a protection path for any one of paths respectively corresponding to path IDs of “1” to “n”. Accordingly, both of the “R-APS (signaled)” and the “R-APS (signaling)” are “NR” messages.

Further, a “flag” is set in a path with a path ID=“n+1”, and a “priority” thereof is set to be lower (for example, n+1) than that of paths (with path IDs of 1 to n) for which “flags” are not set. A path having the priority of “n+1” may be treated as a non-existent path in processing in the R-APS processor 15.

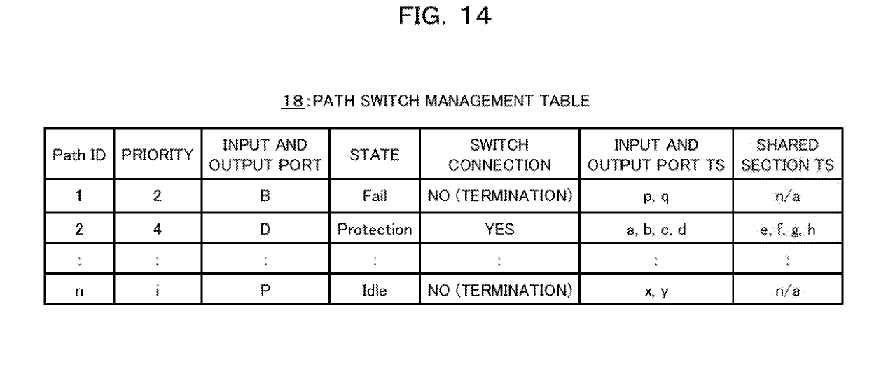

As illustrated in FIG. 14, information for a management of switching of paths may be registered in the path switch management table 18. In FIG. 14, a “transmission speed” indicates a transmission speed requested by a network manager and the like. In an optical transport network (OTN), the transmission speed may be indicated by the number of TSs.

An “Input and output port” indicates a port to which data is input or from which data is output. For example, the node Y includes “B (port connected to the node B)” and “D (port connected to the node D)” as the input and output port. A “State” corresponds to information same as the information managed by the “state” for the TS in the path state management table 17.

A “Switch connection” indicates whether or not the cross connect processing is performed in the switch 20. When the path state is an “idle” state or a “fail” state, the cross connect processing is not performed because a received signal is terminated.

An “Input and output port TS” indicates a TS designated for data transmission in a non-shared section. A “Shared section TS” indicates a TS designated for data transmission in the shared section.

The resource manager 19 may manage an idle resource (for example, a TS) available for data transmission in the shared section.

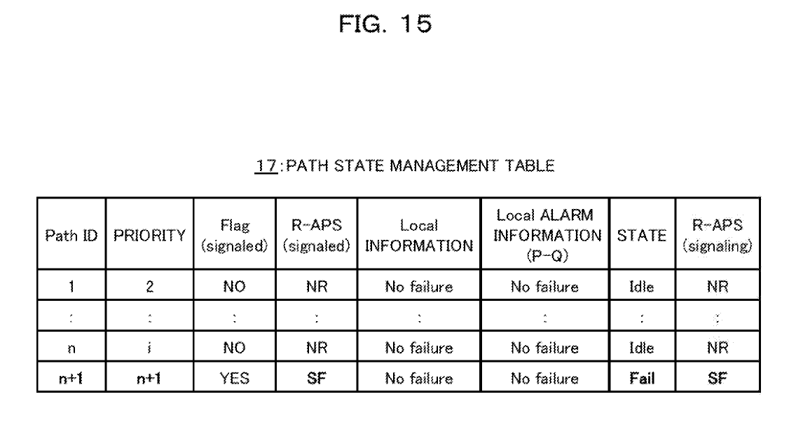

Next, descriptions will be made for an example of updating the path state management table 17 in the node P or Q when a failure occurs in the working path #2 between the nodes C and D, with reference to FIGS. 15 to 17. It can be considered that the example of updating corresponds to the processing S22 illustrated in FIG. 10.

When a failure occurs in the working path #2 between the nodes C and D, the node P or Q receives an SF message from the node C or D. Accordingly, as illustrated in FIG. 15, in the path state management table 17, the R-APS message processor 15 updates both of the “R-APS (signaled)” and the “R-APS (signaling)” to the “SF”, and updates the path state to the “fail” state.

However, since the “flag” in the received SF message indicates an “invalid”, the R-APS processor 15 does not perform the APS operation based on the received SF message. In other words, the path state management table 17 is updated in response to a reception of the SF message, but the SF message is ignored for the APS operation.

When the protection path between the nodes X and Y is unavailable for the working path #2 between the nodes C and D in which a failure occurs, a “flag-off” FS message is received by the R-APS processor 15 in the node P or Q from the node C or D.

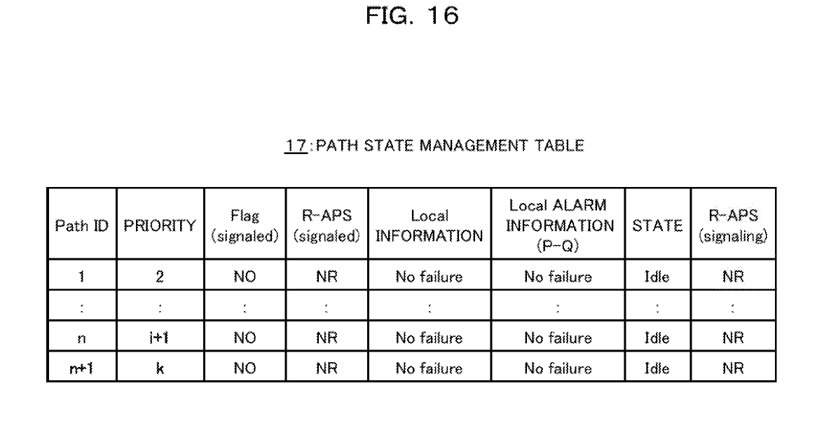

Since the received FS message is a “flag-off” message, the R-APS processor 15 may set a “priority” to paths including a path having a path ID=“n+1”. For example, as illustrated in FIG. 16, the “priority of “n+1” of a path ID “n+1” is changed to “k” (0<k<i; i is an integer of one or greater and indicates a priority).

Further, the R-APS processor 15 transceives an NR message through the path having the path ID “n+1” in response to a detection of the “flag off”. As a result, in FIG. 16, both of the “R-APS (signaled) and the “R-APS (signaling)” are updated to an “NR”, and the path state is updated to an “idle” state.

It is assumed that k=1 which indicates the highest priority and that a failure occur in the working path #2 between the nodes C and D while the path between the nodes X and Y is in use to relieve the working path #1 (with a path ID=1) between the nodes A and B.

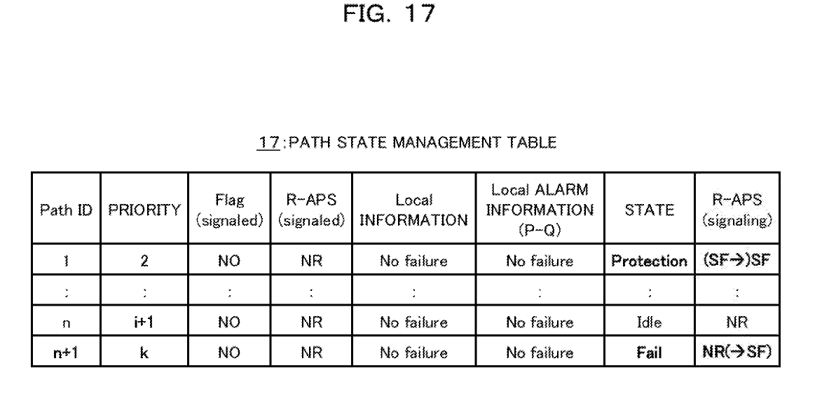

In this case, the path having the path ID=“n+1” and the highest priority k=1 is used as a protection path for the working path #2, Thus, the path state management table 17 is updated as illustrated in FIG. 17, for example.

For example, for the path having the path ID=1, the path state is updated to a “protection” state and the “R-APS (signaling)’ is updated (or maintained) to an “SF”. Further, for the path having the path ID=“n+1”, the path state is updated to a “fail” state because the path is in use to relieve the working path #2 and is unavailable for a protection path for another path. In addition, the “R-APS (signaling)” is updated from the “NR” state to an “SF” state.

As described above, according to the above-described embodiment, it is possible to set a (first) protection path shared by a working path (for example, the working path #2) and another working path #1 and an additional (second) protection path. Even when a plurality of protection paths are set for the working path #2, it is possible to identify the respective protection paths by the VLAN ID of the R-APS message transmitted in the respective protection paths.

Accordingly, even when the working path #2 is not available to use the shared protection path shared by the plurality of working paths #1 and #2 because the shared protection path is used for the working path #1, it is possible to secure another path as a protection path for the working path #2.

Hence, it is possible to prevent the protection path for the working path #2 from being lost, and thus, it is possible to improve a reliability of communication in the network 1.

The above-described example corresponds to an example of “2:1” protection that provides two protection paths for one working path #2. However, three or more protection paths which are identifiable by the VLAN ID may be provided for the working path #2.

In other words, the above-described embodiment can be generalized to an “m:1” protection that provides “m” (m is an integer of two or greater) protection paths identifiable by the VLAN ID for one working path.

Further, the above-described embodiment corresponds to an example in which an “m:1” protection is provided for the working path #2 among the three working paths #1 to #3, but the “m:1” protection is applicable to the other working path #1 or #3 in a manner similar to the above-described embodiment.

In other words, according to the above-described embodiment, it is possible to realize and provide the “m:1” protection of the SMP or the SMR for any of plural working paths in the network 1.

Further, since a valid flag or an invalid flag is applied to the R-APS message transmitted in the respective protection paths, it is possible to adaptively and appropriately select a protection path to be activated among from the plural protection paths. Accordingly, it is possible to prevent a malfunction of the APS operation.

### First Modification Example

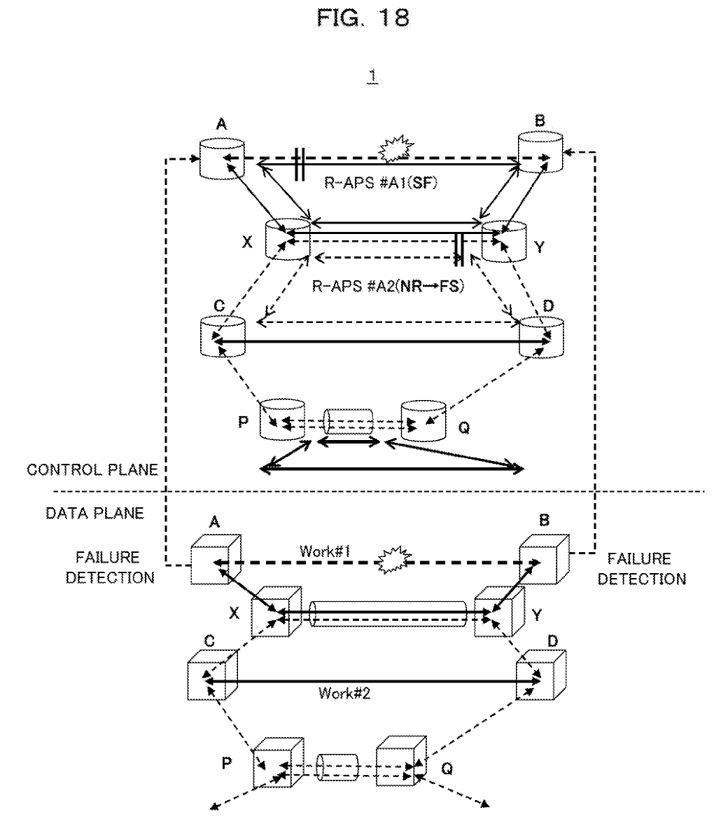

The above-described embodiment (for example, FIG. 8) corresponds to an example in which the R-APS message for the logical ring #B1 is pre-configured. However, as illustrated in FIG. 18, the R-APS message for the logical ring #B1 may be set in response to a state of the logical ring #A2.

For example, the R-APS message for the logical ring #B1 may be set in response to a state transition from the “NR” to the “FS” in the R-APS message transmitted in the logical ring #A2 due to an occurrence of a failure in the working path #1.

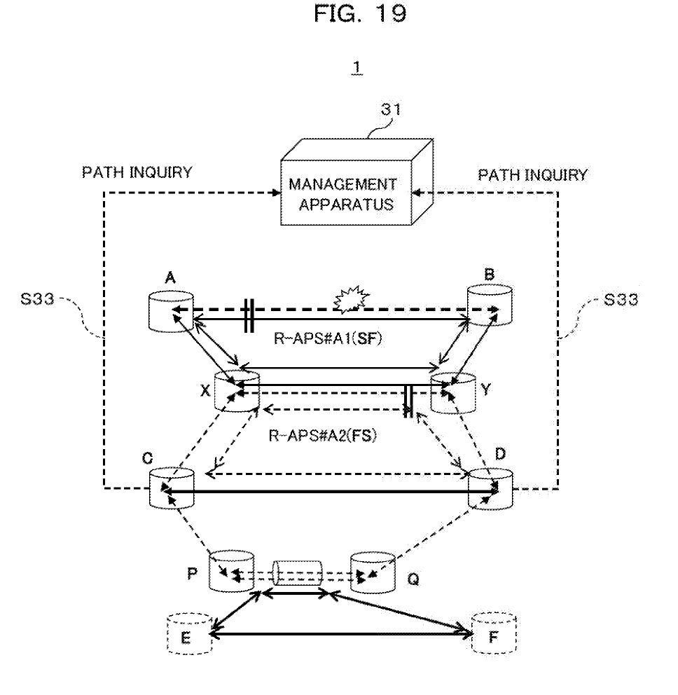

FIG. 19 illustrates a configuration example of the network 1 according to the first modification example. As illustrated in FIG. 19, the network 1 may include a management apparatus (or control apparatus) 31.

The management apparatus 31 may be referred to as a network management system (NMS) or an operation system (OPS). The management apparatus 31 may be communicably connected to the nodes A to D, and nodes X, Y, P, and Q.

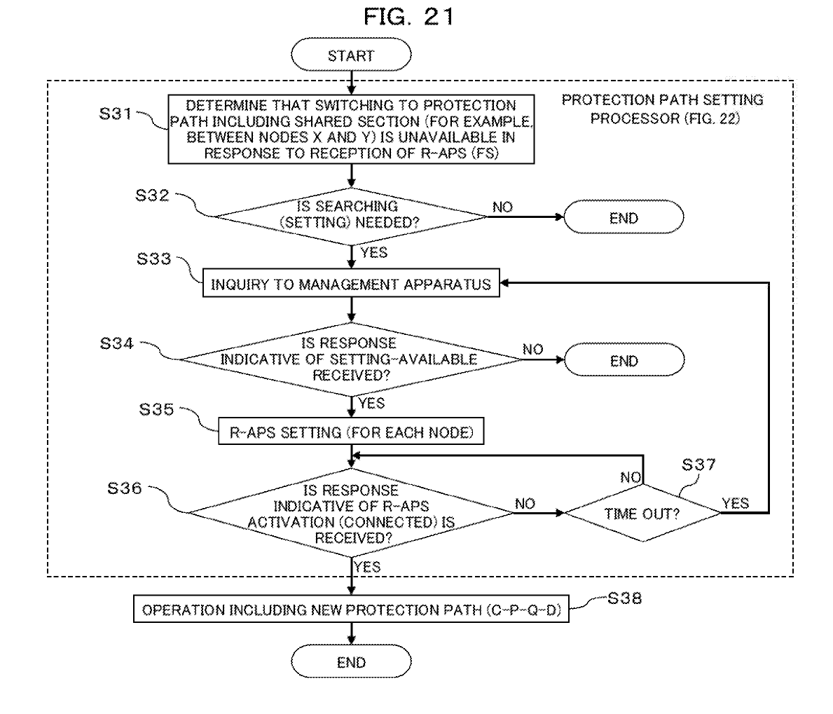

When the nodes C and D detects that a state of the R-APS message received through the logical ring #A2 transitions from the “NR” to the “FS”, the nodes C and D recognize that a protection path routed through the nodes X and Y is unavailable (processing S31 in FIG. 21).

In response to a reception of the FS message, the nodes C and D may determine whether or not it is necessary to search and set a protection path candidate alternative to the protection path routed through the nodes X and Y (processing S32 in FIG. 21). It may be pre-set whether or not the protection path candidate is to be searched and set.

When the alternative protection path candidate is unnecessary to be searched and set (NO in processing S32), the nodes C and D may end the processing.

When the alternative protection path candidate is necessary to be searched and set (YES in processing S32), the nodes C and D may transmit an inquiry for a possible route in which the alternative protection path can be set to the management apparatus 31 (processing S33 in FIGS. 19 and 21).

The management apparatus 31 performs, in response to the inquiry, a route calculation for the possible route available for the alternative protection path based on topology information of the network 1.

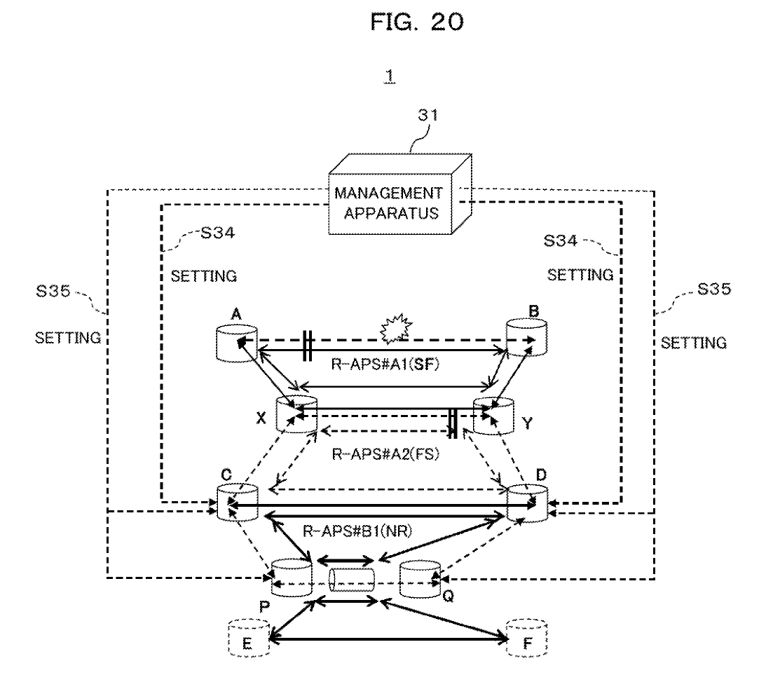

Upon obtaining the possible route available for the alternative protection path by the route calculation, the management apparatus 31 may transmit to the source nodes C and D of the inquiry a response indicating that the setting for the alternative protection path is available (processing S34 in FIG. 20). For example, it is assumed that the route C-P-Q-D routed through the nodes C, P, Q, and D is obtained by the route calculation.

The management apparatus 31 may transmit setting information, which defines processing of the R-APS message in the logical ring #B1 corresponding to the route C-P-Q-D, to the respective nodes C, P, Q, and D which form a logical ring R-APS #B (processing S35 in FIG. 20).

The nodes C and D may monitor whether or not a response indicating, which indicates a setting of the alternative protection path is available, is received from the management apparatus 31 (processing S34 in FIG. 21).

When the response indicating that the setting is available is not received from the management apparatus 31 (NO in processing S34 in FIG. 21), the nodes C and D may end the processing.

Meanwhile, the response indicating that the setting is available is received from the management apparatus 31 (YES in processing S34 in FIG. 21), the nodes C and D performs a transmission and reception setting of the logical ring #B1 in accordance with the setting information received from the management apparatus 31, and activates the logical ring #B1 (processing S35 in FIGS. 20 and 21).

As in the nodes C and D, the nodes P and Q also performs a setting for processing of the R-APS message in the logical ring #B1 in accordance with the setting information received from the management apparatus 31, and activates the logical ring #B1.

In response to the activation of the logical ring #B1, the nodes C, P, Q, and D start transceiving the R-APS message (for example, the NR message) through the logical ring #B1. The nodes C and D may check whether or not the R-APS message is actually received through the logical ring #B1 to confirm a connectivity of the logical ring #B1 (processing S36 in FIG. 21).

The nodes C and D may continuously confirm the connectivity of the logical ring #B1 until a set time expires (time-out) (NO in processing S36 and processing S37 in FIG. 21).

When the connectivity of the logical ring #B1 is not confirmed even after a set time is timed out (NO in processing S36 and YES in processing S37 in FIG. 21), the nodes C and D may transmit an inquiry for a possible route to the management apparatus 31 again (processing S33 in FIG. 21).

Meanwhile, the connectivity of the logical ring #B1 is confirmed before the set time is timed out (YES in processing S36 in FIG. 21), the nodes C and D may use the logical ring #B1 (processing S38 in FIG. 21). Similarly, the nodes P and Q may use the logical ring #B1 upon confirming the connectivity of the logical ring #B1.

As described above, according to the first modification example, in addition to the same technical advantages as in the above-described embodiment, it is possible to adaptively set the R-APS message for the logical ring #B1 in response to a state of the logical ring #A2. Accordingly, it is possible to simplify an APS setting work in comparison with the example in which the setting is pre-configured as in the above-described embodiment.

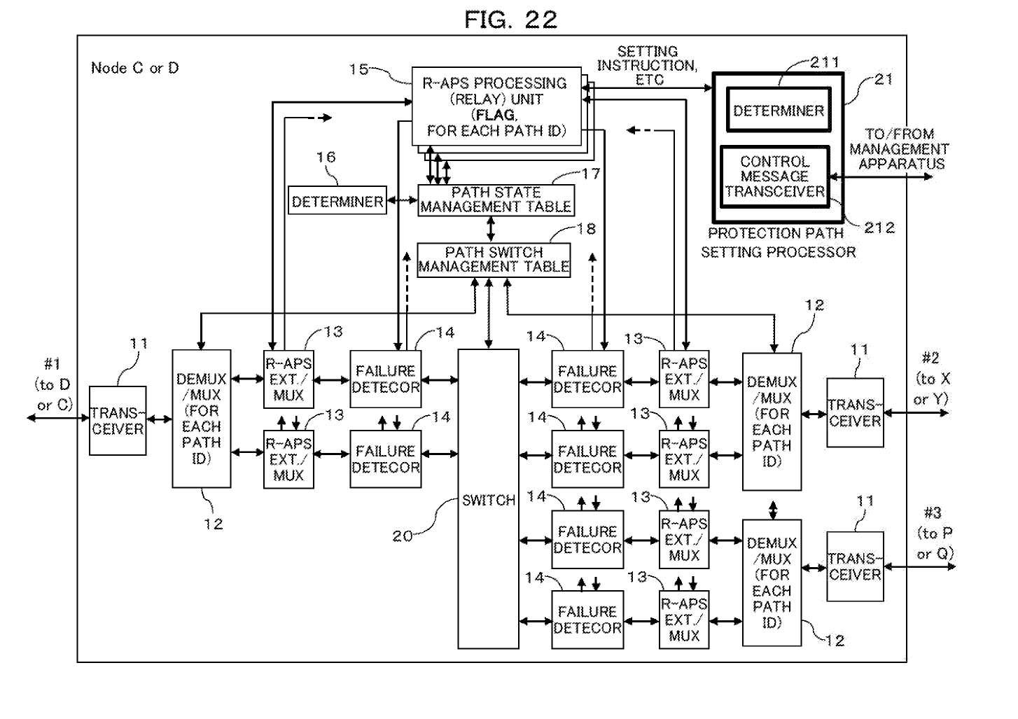

FIG. 22 illustrates a configuration example of the nodes C and D according to the first modification example. The configuration illustrated in FIG. 22 is different from the configuration illustrated in FIG. 11 in that a protection path setting processor 21 is added.

It can be considered that processing S31 to processing S37 illustrated in FIG. 21 are performed by the protection path setting processor 21. For example, the protection path setting processor 21 includes a determiner 211 and a control message transceiver 212.

The control message transceiver 212 transmits a message of an inquiry to the management apparatus 31. Further, the control message transceiver 212 receives from the management apparatus 31 a control message which may include a response to the inquiry for a possible route and/or setting information of a logical ring (for example, #B1) corresponding to the alternative protection path.

Accordingly, the control message transceiver 212 is an example of a second transmitter that transmits an inquiry for a protection candidate to the management apparatus 31. Further, the control message transceiver 212 is also an example of a second receiver that receives information of the protection path candidate from the management apparatus 31.

The determiner 211 may perform processing of: determining a state of the logical ring #A2; determining the state of the logical ring #B1; and providing setting information for the logical ring #B1 to the R-APS processor 15 to instruct a setting of the logical ring #B1.

A configuration example of the nodes P and Q may be the same as or similar to the configuration example of the nodes C and D illustrated in FIG. 22. However, the processing of determining the state of the logical ring by the determiner 211 and the processing of the inquiry for a possible route to the management apparatus 31 by the control message transceiver 212 may be unnecessary.

In the node configuration example illustrated in FIGS. 11 and 12, the logical ring #B1 is statically pre-set without depending on a state of the logical ring #A2, and thus, the protection path setting processor 21 is not illustrated in the drawings. However, the protection path setting processor 21 may be provided in the node configuration example in FIGS. 11 and 12. In this case, the protection path setting processor 21 may be dynamically activated when a setting for the logical ring #B1 is performed in response to the state of the logical ring #A2.

### Second Modification Example

The first modification example corresponds to an example in which the management apparatus 31 performs the transmission and reception setting of the R-APS message in the logical ring #B1 for the nodes C, P, Q, and D which are positioned in a route in which the alternative protection path can be set.

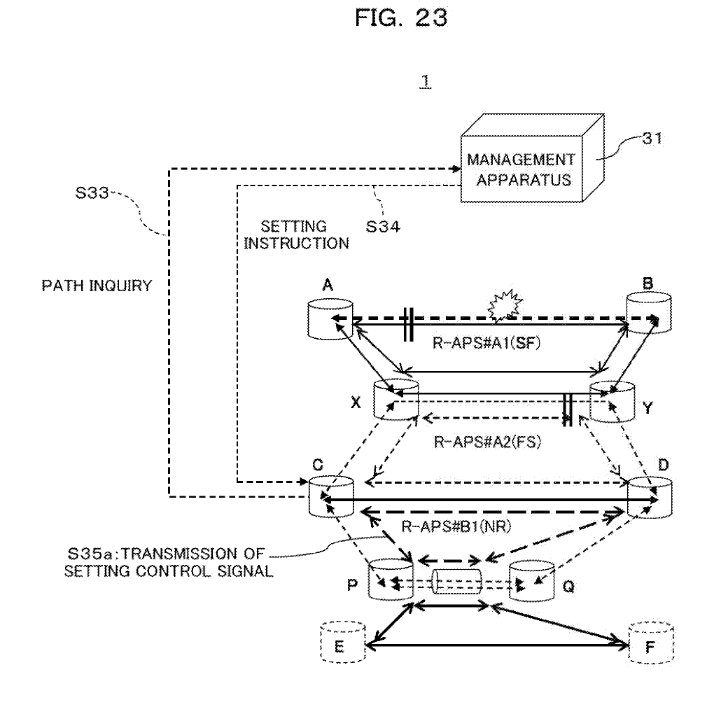

In contrast, in the second modification example, as illustrated in FIG. 23, the management apparatus 31 may perform setting of the R-APS message in the logical ring #B1 for any one (for example, the node C) of the nodes C, P, Q, and D (processing S34).

The node C for which the setting is performed may transmit a control signal to the other nodes P, Q, and D which form the logical ring #B1 to perform the same setting of the R-APS message in the logical ring #B1 as in the first modification example.

As described above, according to the second modification example, in addition to the same technical advantages as in the embodiment and the first modification example, the management apparatus 31 is not needed to perform the setting for all of the nodes C, P, Q, and D which form the logical ring #B1. Accordingly, it is possible to reduce a load of the management apparatus 31.

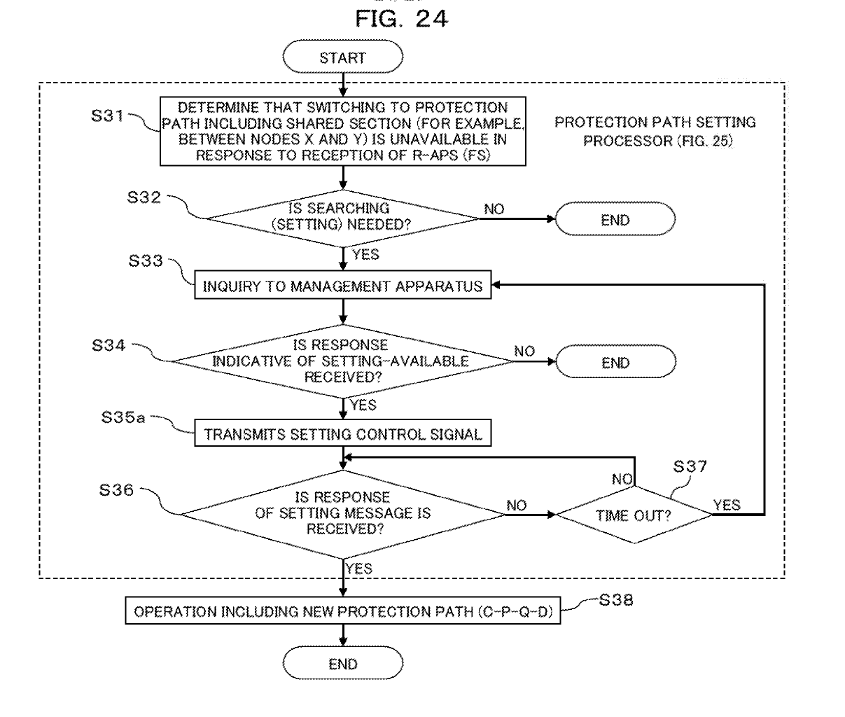

FIG. 24 illustrates an operation example of the nodes C and D according to the second modification example. FIG. 24 is different from FIG. 21 in the first modification example in that processing S35 is replaced with processing S35a.

In processing S35a, the node C may transmit, based on setting information received from the management apparatus 31, a setting control signal including setting information that defines processing of the R-APS message to the other nodes P, Q, and D which form the logical ring #B1.

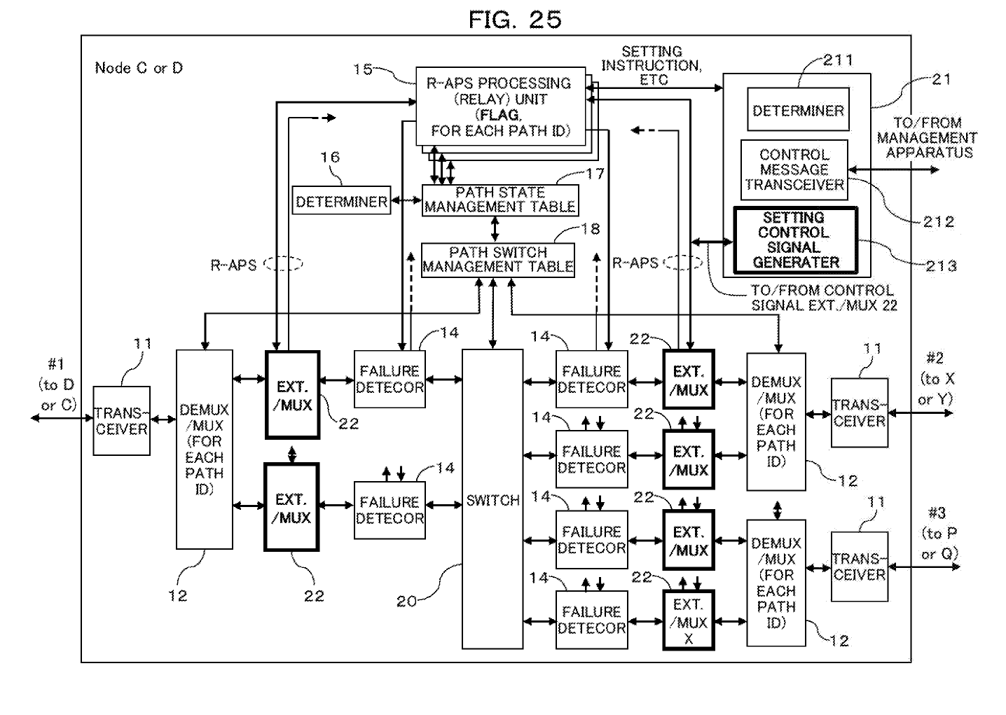

FIG. 25 illustrates a configuration example of the node C according to the second modification example. As illustrated in FIG. 25, for example, the node C of the second modification example is different from the configuration example of the first modification example (FIG. 22) in that a setting control signal generator 213 is added in the protection path setting processor 21.

Further, in FIG. 25, the R-APS EXT/MUX 13 illustrated in FIG. 22 may be replaced with a control signal extracting and multiplexing unit (a control signal EXT/MUX) 22. The control signal EXT/MUX 22 may have the same function as that of the R-APS EXT/MUX 13.

The setting control signal generator 213 may generate a setting control signal for the other nodes P, Q, and D based on setting information received by the control message transceiver 212 from the management apparatus 31. The generated setting control signal may be multiplexed to each of paths corresponding to the other nodes P, Q, and D by the control signal EXT/MUX 22 and may be transmitted to the nodes P, Q, and D.

The setting control signal generator 213 is an example of a third transmitter. The third transmitter 213 transmits setting information, which defines processing of the R-APS message in the logical ring #B1, to nodes other than a node through which the logical ring #B1 corresponding to the second protection path is routed based on the setting information received by the control message transceiver 212.

A configuration example of the nodes P, Q, and D may be the same as or similar to that in FIG. 25, and the control signal EXT/MUX 22 is available to extract the setting control signal transmitted by the node C. The extracted setting control signal may be given to the R-APS processor 15. The R-APS processor 15 can perform, based on the setting control signal, setting processing of a transmission and a reception for the R-APS message to be transmitted through the logical ring #B1.

A control signal multiplexed or extracted by the control signal EXT/MUX 22 may include the R-APS message in addition to the setting control signal. In other words, the control signal EXT/MUX 22 may be common to a multiplexing and extraction of the setting control signal and a multiplexing and extraction of the R-APS message.

In the second modification example, the processing of determining a state of the logical ring by the determiner 211 and the processing of an inquiry for a possible route to the management apparatus 31 by the control message transceiver 212 may be unnecessary in the nodes P and Q as in the first modification example.

Others

The embodiment including the modification examples is applicable to, for example, a network that transmits packet data in addition to a time-division multiplex (TDM) network such as the OTN. For example, the embodiment including the modification examples is applicable to the Ethernet (registered trademark), a multi-protocol label switching (MPLS) network.

In the node configurations illustrated in FIGS. 11, 12, 22, and 25, a band control unit may be provided between the failure detector 14 and the switch 20 for each path.

The band controller may be realized by, for example, a shaper or a policer, and a transmission amount of packet data (or pack transmission interval) may be controlled in accordance with a transmission band designated for each path.

Alternatively, the band controller may discard received packet data in accordance with the transmission band designated for each path. The transmission band of a path may be notified to a target node by using the R-APS message, for example. A signaling extension including information which requests for the transmission band may be applied to the R-APS message instead of a “GMPLS ODU Signaling”.

### Hardware Configuration Example of Node

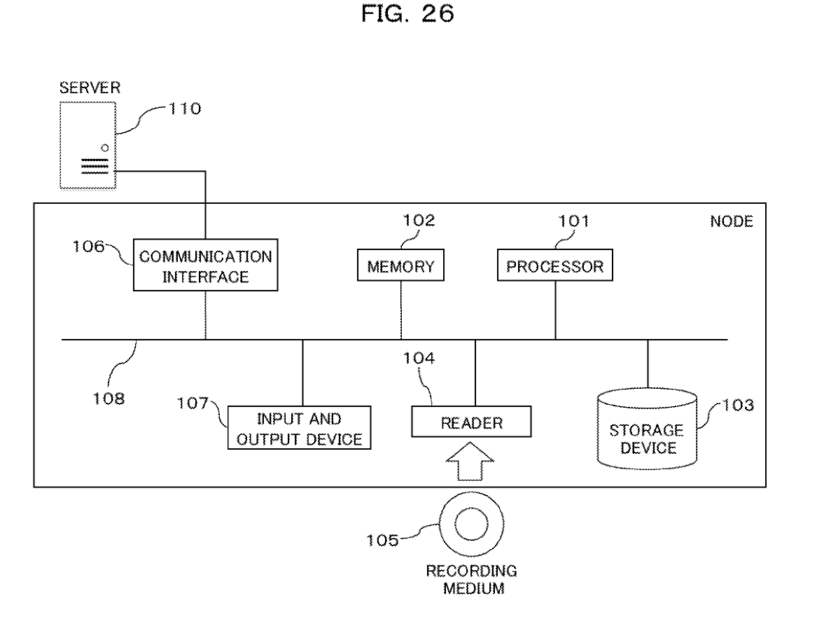

FIG. 26 is a block diagram illustrating a hardware configuration example of a node according to the embodiment including the modification examples.

For example, the node may include a processor 101, a memory 102, a storage device 103, a reader 104, a communication interface 106, and an input and output device 107.

For example, the processor 101, the memory 102, the storage device 103, the reader 104, the communication interface 106, and the input and output device 107 may be connected to each other through a bus 108.

The processor 101 may be a hardware circuit or a device having an arithmetic capacity and may be a central processing unit (CPU) as an example. The processor 101 can realize the operation in the node, which is described in the embodiment including the modification examples, by executing a program while using the memory 102.

The memory 102 may be a semiconductor memory, and may include a random access memory (RAM) region, and a read only memory (ROM) region.

The storage device 103 may be a hard disk device, and may store a program that realizes the operation in the node as described above. Further, the storage device 103 may be a semiconductor memory such as a flash memory. Furthermore, the storage device 103 may be an external storage device. The path state management table 17 and the path switch management table 18 may be stored in the memory 102 and/or the storage device 103.

The reader 104 may access a portable recording medium 105 in accordance with an instruction by the processor 101. The portable recording medium 105 may be a semiconductor device such as a USB memory, a medium such as a magnetic disk to and from which information is input and output by using a magnetic action, a medium such as a CD-ROM and a DVD to and from which information is input and output by using an optical action.

The communication interface 106 is available to transmit and receive data through a network in accordance with an instruction by the processor 101.

The input and output device 107 may include a device that receives an instruction or a setting from a network manager and/or a device that outputs a processing result of the processor 101.

A program possible to realize the operation in the node, which is described in the embodiment including the modification examples, may be installed in the storage device 103 in advance, may be provided by the portable recording medium 105, or may be provided from a server 110.

According to the technology, for a second working path that shares a protection path together with the first working path, it is possible to set another protection path identifiable from the shared protection path. Thus, it is possible to improve a communication reliability.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment(s) of the present invention have been described in detail, it should be understood that the various changes, substitutions, and alterations could be made hereto without departing from the spirit and scope of the invention.

What is claimed is:

1. A transmission apparatus comprising:
a first receiver configured to receive from a first protection path an automatic protection switching (APS) signal indicating that a first working path in which a failure occurs is to be switched to the first protection path shared by the first working path and a second working path;
a first transmitter configured to transmit an APS signal applied with a first virtual local area network identifier (VLAN ID) to the first protection path and to transmit an APS signal applied with a second VLAN ID to a second protection path that is a protection path candidate for the second working path, in response to a reception of the APS signal.

2. The transmission apparatus according to claim 1,
wherein the first transmitter
applies flag information, which indicates that an operation based on the APS signal is invalid, to the APS signal applied with the first VLAN ID, and
applies flag information, which indicates that the operation based on the APS signal is valid, to the APS signal applied with the second VLAN ID.

3. The transmission apparatus according to claim 1, further comprising:
a second transmitter configured to transmit an inquiry for the protection path candidate to a management apparatus of a network including the transmission apparatus; and
a second receiver configured to receive setting information of an APS signal for the protection path candidate from the management apparatus.

4. The transmission apparatus according to claim 3, further comprising:
a third transmitter configured to transmit setting information, which defines a process for an APS signal in the second protection path, to another transmission apparatus through which the second protection path is routed based on the setting information received by the second receiver.

5. A transmission system comprising:
a first working path;
a second working path;
a first protection path that is shared by the first working path and the second working path;
a first transmission apparatus through which the first protection path is routed; and
a second transmission apparatus through which the second working path is routed,
wherein the first transmission apparatus is configured to transmit to the first protection path an automatic protection switching (APS) signal indicating that a first working path in which a failure occurs is to be switched to the first protection path, and
the second transmission apparatus is configured to transmit an APS signal applied with a first virtual local area network identifier (VLAN ID) to the first protection path in response to a reception of the APS signal through the first protection path, and to transmit an APS signal applied with a second VLAN ID to a second protection path that is a protection path candidate for the second working path.
